(19) United States
(12) Patent Application Publication
(10) Pub. No.: US 2004/0073934 A1
(43) Pub. Date: Apr. 15, 2004

(54) Streaming video for adaptive user instructions

(75) Inventors: Sachin Govind Deshpande, Vancouver, WA (US); John Calvin Thomas, Portland, OR (US); Michael Douglas Baker, Vancouver, WA (US)

Correspondence Address: LAW OFFICE OF KAREN DANA OSTER, LLC, PMB 1020, 15450 SW BOONES FERRY ROAD #9, LAKE OSWEGO, OR, 97035, US

(73) Assignee: Sharp Laboratories of America, Inc., Camas, WA

(21) Appl. No.: 10/261,566

(22) Filed: Sep. 30, 2002

(51) Int. Cl. H04N 7/173; G06F 3/00; H04N 5/445; H04N 7/16; G06F 13/00

(52) U.S. Cl. 725/87; 725/37; 725/135

(57) ABSTRACT

A multifunction peripheral configured to display instructional streaming videos or multimedia includes an error generator, print controller, address generator, client system, and display. The error generator is for generating at least one multifunction peripheral error signal in response to a multifunctional peripheral error or user request. The print controller receives the multifunction peripheral error signal and passes it to the address generator that generates an address based on the multifunction peripheral error signal. The client system then passes the address to an internal or external server system that returns the requested video or multimedia to the client system. The video or multimedia is then displayed on the display. Exemplary multifunctional peripheral errors include simple maintenance problems, everyday problems associated with basic maintenance and servicing, and technical problems including initial installation and field upgrades of hardware and software. The present invention also includes a method performed by a multifunction peripheral that provides streaming video and/or multimedia for adaptive user instructions in response to a multifunction peripheral error and/or user interaction.

### BACKGROUND OF INVENTION

The present invention is directed to multifunction peripherals and more specifically to a multifunction peripheral configured to display instructional streaming videos or multimedia.

Peripheral devices allow users to put information into or get information out of a computer system. Peripheral devices include, but are not limited to, printers, scanners, copiers, media readers, and facsimile machines. Earlier generations of peripheral devices performed a single function, but many peripheral devices today are able to perform multiple functions. A multifunction peripheral (MFP) is a peripheral device that can perform the functions of more than one traditional peripheral device. For example, a single device that can perform all the functions of a printer, scanner, copier, media readers, and facsimile machine is a multifunction peripheral. Multifunction peripherals have become commonplace in many commercial settings. Multifunction peripherals such as Sharp's AR-M350 and AR-M450 Digital Imager, not only afford a client multifunctional capability, as previously described, but also the flexibility of printing/copying on both sides of the paper, a choice of at least four paper sizes, paper collation, and stapling. Other exemplary multifunction peripherals include Sharp's AR-505 printer/copier.

Although multifunction peripherals have clear advantages over their single function predecessors, a disadvantage of these machines is that their level of sophistication frequently makes servicing them or even using them problematic. A first example of a problem encountered when using multifunction peripherals is the simple maintenance problem of a paper jam. When a paper jam occurs the user will need to access the machine in various locations to identify and remove the paper jam. The paper jam could be located in the scanning portion of the multifunction peripheral or the copier/printer portion. A second example of problems encountered when using multifunction peripherals are the everyday problems of basic maintenance and servicing such as adding paper, ink, toner, staples, and developer. These everyday problems, while no problem to a sophisticated user or a user familiar with a particular multifunction peripheral, can confuse infrequent users or less sophisticated users of a multifunction peripheral. A third example of problems encountered when using multifunction peripherals are true technical problems. True technical problems are generally more complicated and generally require a service technician to fix or repair. True technical problems, for purposes of this disclosure, also include installation of initial hardware and software or field upgrades. A fourth example of problem encountered when using multifunction peripherals involve the basic functions of the multifunction peripheral. Some users may have difficulties navigating the user interface to identify and use basic functions of interest. For example, a walk-up user may want to collate and staple output papers or transmit a document to a remote party using the network scanner.

Typical multifunction peripherals have associated written (hardcopy or electronic) user manuals or materials. When a user encounters a problem or desires to access a function, the user must read the often-convoluted documentation, determine if the particular problem is discussed in the materials, and then follow sketchy and difficult to understand instructions. This generally requires a significant time investment to solve a particular problem or access a particular function. It also assumes that the written materials are available to the user.

Newer or higher-end multifunction peripherals may include a few lines of textual instructions on an integral user interface display. This type of integral user interface may be used in a menu-like fashion or to provide simple textual messages. For example, a properly functioning multifunction peripheral may indicate that it is “ready.” Everyday problems or simple problems may trigger the display of error messages or instructions such as “low ink,” “load paper,” or “paper jam” on the user interface display. This type of multifunction peripheral may also display a numerical error code on the user interface. The error message, instructions, or code may give the user some idea of what the problem is, but it generally requires an unskilled user to return to the written materials to solve the problem.

Expensive commercial multifunction peripherals may include a larger user interface display for displaying static images. These prior art devices may have help menus accessible from the user interface or, when an error occurs, instructions are automatically made available to the user. Instructions may be accompanied by a schematic drawing showing the part of the multifunction peripheral to be accessed along with arrows or other directional/positional indications. The schematic drawings may further show the relevant components of the multifunction peripheral to be manipulated in order to maintain the machine and directional arrows. These static images, however, are extremely limited in detail and it is often difficult to determine what they are actually depicting. In addition, even if directional arrows are present, their meaning can be difficult to interpret.

U.S. Pat. No. 6,285,932 to de Bellefeuille et al. is directed to a computerized automotive service system. The de Bellefeuille disclosure cursorily indicates that the de Bellefeuille system may include an instruction screen that can display illustrations, video, audio, text, or any combination thereof. Although the de Bellefeuille system is directed to a service system for automobiles, it does illustrate that video can be useful in helping service technicians. The user of the de Bellefeuille system, however, is most likely a trained operator or service technician that would not need significant detailed video instructions.

### BRIEF SUMMARY OF THE INVENTION

The present invention is directed to a multifunction peripheral configured to display instructional streaming videos or multimedia. The multifunctional peripheral includes an error generator for generating at least one multifunction peripheral error signal in response to a multifunctional peripheral error or user request. A print controller or a signal receiver of the multifunctional peripheral receives the multifunction peripheral error signal. An address generator then generates an address based on the multifunction peripheral error signal. A client system receives the address and passes it to a server system that returns the requested video or multimedia to the client system. The video or multimedia is then displayed on the display. Exemplary multifunctional peripheral errors include simple maintenance problems, everyday problems associated with basic maintenance and servicing, and technical problems including initial installation and field upgrades of hardware and software.

The present invention also includes a method performed by a multifunction peripheral that provides streaming video and/or multimedia for adaptive user instructions in response to a multifunction peripheral error and/or user interaction.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a block diagram of a first exemplary embodiment multifunction peripheral that includes an RTSP client and provides streaming video and/or multimedia for adaptive user instructions in response to a multifunction peripheral error and/or user interaction.

FIG. 2 is a block diagram of a second exemplary embodiment multifunction peripheral that includes both an RTSP client and an HTTP client and provides streaming video and/or multimedia for adaptive user instructions in response to a multifunction peripheral error and/or user interaction.

FIG. 3 is a block diagram of a third exemplary embodiment multifunction peripheral that includes an internal video or multimedia database or archive and provides streaming video and/or multimedia for adaptive user instructions from an internal video or multimedia player in response to a multifunction peripheral error and/or user interaction.

FIG. 4 is a flow diagram of a simplified method performed by a multifunction peripheral that provides streaming video and/or multimedia for adaptive user instructions in response to a multifunction peripheral error and/or user interaction.

FIG. 5 is a front view of a simplified exemplary multifunction peripheral having a user interface and a display suitable for displaying streaming video and/or multimedia for adaptive user instructions.

### DETAILED DESCRIPTION OF THE INVENTION

The present invention is directed to a multifunction peripheral that adds streaming video and/or multimedia for adaptive user instructions. A multifunction peripheral of the present invention is configured to display instructional streaming video and/or multimedia upon a user interaction such as when a user requests assistance using the multifunction peripheral's user interface or at least partially automatically upon the occurrence of a multimedia peripheral error such as a technical problem or a need for maintenance. By accessing and displaying multimedia data, this invention permits a richer and more useful user experience for frequently and infrequently performed installation, maintenance, or repair operations or basic functions of the multifunction peripheral. Another example of the benefits of the instructional video and/or multimedia involves the use of audio. By using audio playback, the multifunction peripheral is able to coach the user, even when the user's eyes are focused on the inner workings of the multifunction peripheral and away from the user interface display. Audio also makes possible the reproduction of sounds made by a malfunctioning multifunction peripheral, thereby assisting the diagnosis of repair problems. For certain types of errors, audio may also function as an immediate alarm. The audio may be played through the multimedia display or over a separate audio speaker.

One type of multimedia peripheral error is a simple maintenance problem such as a paper jam. When a paper jam occurs, the user will need to access the machine in various locations to identify and remove the paper jam. The paper jam could be located in the scanning portion of the multifunction peripheral or the copier/printer portion. For this type of problem, the present invention may provide a full motion video that shows the proper body movements of the maintenance person during the operation of fixing the paper jam. A video depiction provides a more obvious indication of dangerous and/or sensitive areas of the multifunction peripheral than is possible with text or static images. Further, the video depiction can show the “best body position” to perform efficiently each operation. Best body position would be almost impossible to explain with just text and static images. Once an error is detected, relevant portions of a video illustrating where the paper jam is located, the proper way to access the multifunction peripheral, and how to remove the paper jam will be displayed on the user interface display. The user will be able to follow this “real demonstration” to maintenance the machine. Further, by including audio in the multimedia presentation, the multifunction peripheral is able to coach the user, even when the user's eyes are focused on the inner workings of the multifunction peripheral and away from the user interface display. If the user attempts to do something that is dangerous or potentially harmful to the multifunction peripheral, the multifunction peripheral may be able to sense the error and automatically provide a video or audio presentation that functions as an immediate alarm.

Another type of multimedia peripheral error includes everyday problems such as basic maintenance and servicing. Basic maintenance and servicing may include such everyday problems as adding paper, ink, toner, staples, and developer. While these would not be considered a problem to a sophisticated user or a user familiar with a particular multifunction peripheral, infrequent users or less sophisticated users of a multifunction peripheral would find this everyday maintenance confusing. For this type of problem, the present invention may provide a full motion video that shows the proper body movements of the maintenance person adding paper, ink, toner, staples, and developer. Compared to text or static images, a video depiction generally provides a more obvious indication of dangerous and/or sensitive areas of the multifunction peripheral and is able to show the “best body position” to perform efficiently each operation. Once a maintenance error is detected, relevant portions of a video illustrating where the paper tray/ink/toner/staples/developer is located, the proper way to access the multifunction peripheral, and how to remove and replace the tray/ink/toner/staples/developer will be displayed on the user interface display. One case where this invention would be useful is the toner replacement instructions for the Sharp AR-505 printer/copier. The existing instructions that describe the removal of the toner cartridge tape seal are vague and it is not clear how textual descriptions would enhance the user's understanding of this procedure. Since the consequences of incorrectly performing this procedure are serious, a full-motion video of the procedure would be welcomed. Further, by including audio in the multimedia presentation, the multifunction peripheral is able to coach the user, even when the user's eyes are focused on the inner workings of the multifunction peripheral and away from the user interface display. If the user attempts to do something that is dangerous or potentially harmful to the multifunction peripheral, the multifunction peripheral may be able to sense the error and automatically provide a video or audio presentation that functions as an immediate alarm.

Yet another type of multimedia peripheral error includes true technical problems. True technical problems are generally more complicated and generally require a service technician to fix or repair and, therefore are generally quite expensive. True technical problems, for purposes of this disclosure, also include installation of new hardware and software. A multimedia peripheral incorporating the present invention may be used to help diagnose and repair certain types of true technical problems that would otherwise require a service technician. For example, an error code could generate a video to be displayed that demonstrates to the user where and how to find certain diagnostic clues as to the technical problem. The user could use the user interface to display a series of possible problems until the exact problem is discovered. Audio may also be used to reproduce sounds made by a malfunctioning multifunction peripheral, thereby assisting the diagnosis of repair problems. Once the problem is diagnosed, the multifunction peripheral could provide an instructional video that shows the proper body movements of the maintenance person fixing the problem. Compared to text or static images, a video depiction generally provides a more obvious indication of dangerous and/or sensitive areas of the multifunction peripheral and is able to show the “best body position” to perform efficiently each operation. Further, by including audio in the multimedia presentation, the multifunction peripheral is able to coach the user, even when the user's eyes are focused on the inner workings of the multifunction peripheral and away from the user interface display. If the user attempts to do something that is dangerous or potentially harmful to the multifunction peripheral, the multifunction peripheral may be able to sense the error and automatically provide a video or audio presentation that functions as an immediate alarm.

Sometimes using a multifunction peripheral's basic functions is even problematic. For example, users may have difficulties navigating the user interface to identify and use basic functions of interest. For example, a walk-up user may want to collate and staple output papers or transmit a document to a remote party using the network scanner. For this type of problem, video clips illustrating how to access certain functions on the user interface, including instructions illustrating the use of the collation and network scanning function will be viewable from the user interface. The user may specifically request instructions using the user interface or, if certain combinations of instructions are provided to the multifunction peripheral, the user could be prompted that video instructions are available.

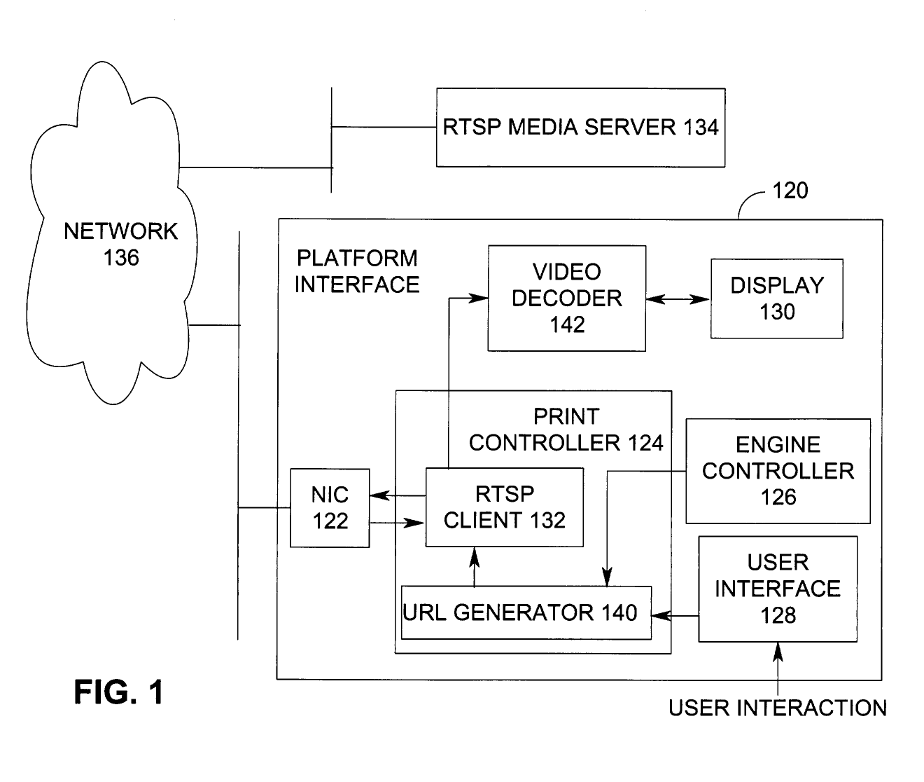

FIGS. 1-3 show exemplary embodiments of a multifunction peripheral configured to display instructional streaming videos or multimedia based on a multifunction peripheral error or upon user interaction. In these exemplary embodiments of the invention, Real-Time Streaming Protocol (RTSP) and Hyper-Text Transfer Protocols (HTTP) are used. Those skilled in the art, however, will realize that the invention can be implemented using other protocols known and yet to be conceived that are capable of providing multimedia presentations on the user interface.

A multifunction peripheral 120 of the present invention typically consists of a Network Interface Controller (NIC) 122, a print controller 124, an engine (with a possibly separate controller) 126, a user interface 128 through which the user may interact with the multifunction peripheral, and display 130 for displaying video or multimedia presentations or playing audio. The NIC 122 may support one or more high-speed interfaces including, for example, USB and/or Ethernet. An Ethernet interface may support multiple network stacks such as FTP, HTTP, SNMP, and other TCP/IP socket-based protocols. The addition of a streaming video protocol (such as RTSP) to the NIC 122, print controller, or as a separate module of the multifunction peripheral 120, makes this invention possible in any multifunction peripheral that has appropriate user interface display hardware.

FIG. 1 shows a first exemplary embodiment of the multifunction peripheral 120. In this embodiment, an RTSP client 132 is part of the print controller 124. In this embodiment, the multifunction peripheral 120 is pre-configured with the RTSP server information, or can dynamically discover any available RTSP servers that provide the required service of instructional multimedia. The RTSP client 132 communicates with an RTSP media server 134 through the NIC 122 via a network 136 by sending RTSP commands and receiving a RTSP response and/or a video stream. The print controller 124 acquires an error code from all error reporting modules (e.g. an error generator module and/or engine controller 126). In other cases, the print controller 124 may get a request for information through user interaction with the user interface 128 indicating the type of video/assistance requested. A URL generator module 140 generates the appropriate URL based on the error code and/or user interaction and the RTSP server configuration information. The URL is then passed to the the RTSP client 132. The RTSP client 132 sets up a session and sends commands to the RTSP server 134. The RTSP server 134 can stream the appropriate media data, which the RTSP client 132 can pass to the video decoder module 142. The decoded video output is then displayed on the multifunction peripheral display 130. Although this embodiment is discussed in terms of a remote server, it should be noted that it may be implemented with an internal or local video player (e.g. a DVD player).

An example server-client interaction between the RTSP client 132 and the RTSP server 134 for streaming video using RTSP is shown below. “C” denotes the RTSP client 132 in the multifunction peripheral 120 and “S” denotes the RTSP server 134.

C->S: SETUP rtsp://www.mfpvidsrv.com:554/mfp/vid/err15078.avi

RTSP/1.0

CSeq: 2
Transport: x-sharp-mvt/TCP;interleaved=0
S->C: RTSP/1.0 200 OK
CSeq: 2
Date: 05 Jun 1997 18:57:18 GMT
Transport: x-sharp-mvt/TCP;interleaved=0
Session: 142067
C->S: PLAY rtsp://www.mfpvidsrv.com:554/mfp/vid/err15078.avi

RTSP/1.0

CSeq: 3
Session: 142067
S->C: RTSP/1.0 200 OK
CSeq: 3
Session: 142067
Date: Mon, 06 Aug 2001 20:11:35 GMT
RTP-Info:

url=rtsp://www.mfpvidsrv.com:554/mfp/vid/err15078.avi;seq=
0;rtptime=0

$\000{LengthByte1 LengthByte2}{LengthByte size data= one upper

layer PDU}

$\000{LengthByte1 LengthByte2}{LengthByte size data}
$\000{LengthByte1 LengthByte2}{LengthByte size data}

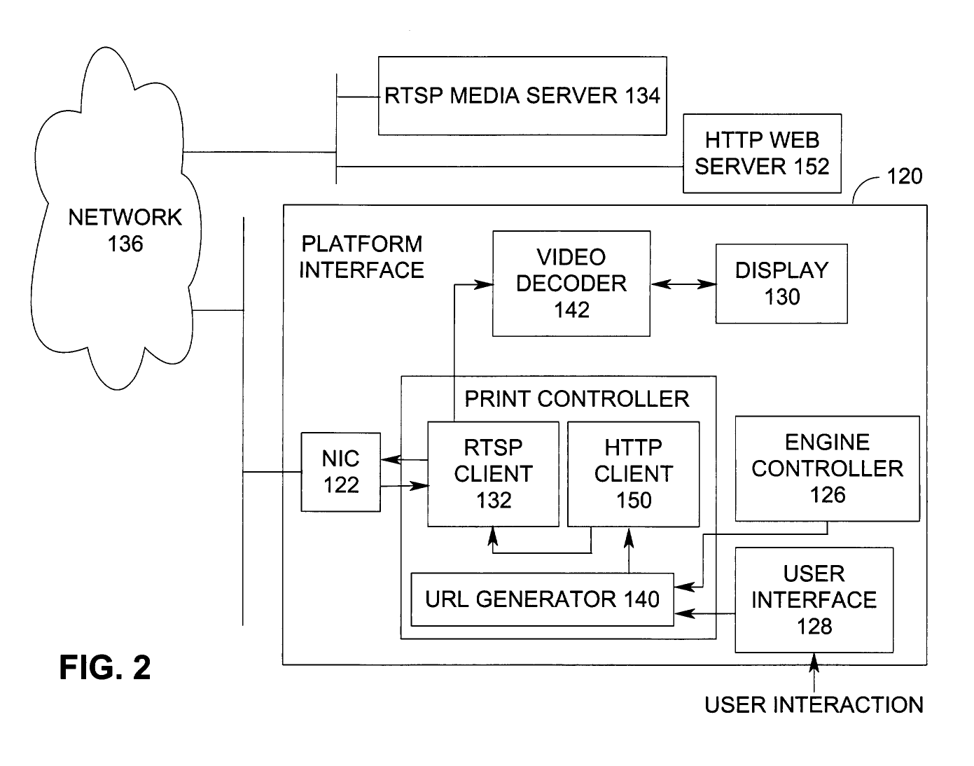

FIG. 2 shows a second exemplary embodiment of the multifunction peripheral 120 in which both a HTTP client 150 and a RTSP client 132 are part of the print controller 124. The multifunction peripheral 120 is pre-configured with the HTTP server 150 information, or can dynamically discover any available HTTP servers that provide required service of instructional multimedia. The RTSP client 132 communicates with an RTSP media server 134 through the NIC 122 via a network 136 by sending RTSP commands and receiving a RTSP response and/or a video stream. The HTTP client 150 communicates with a HTTP server 152 through the NIC 122 via a network 136 by sending HTTP commands and receiving a HTTP response and/or a video stream. The print controller 124 acquires an error code from all error reporting modules (e.g. engine controller 126). In other cases, the print controller 124 may get a request for information through user interaction with the user interface 128 indicating the type of video/assistance requested. A URL generator module 140 generates the appropriate URL based on the error code and/or user interaction and the HTTP server configuration information and passes this to the HTTP client 150. The HTTP client 150 requests the session description from the HTTP server 152 by passing it the engine error code as part of the URL. The resulting HTTP response (session description) is passed from the HTTP client 150 to the RTSP client 132. The RTSP client 132 sets up the session based on this session description and sends a command to the RTSP server 134. The server can stream the appropriate media data (in the example below using RTP) to the appropriate ports of multifunction peripheral 120. The streamed video data is subsequently passed to the video decoder module 142. The decoded video output is then displayed on the multifunction peripheral display screen 130.

An example server-client interaction between the HTTP client 150 and HTTP server 152, and the RTSP client 132 and the RTSP server 134 for streaming video using RTSP is shown below. “H” denotes the HTTP client 150 in the multifunction peripheral 120 and “W” denotes the HTTP web server 152. “C” denotes the RTSP client 132 in the multifunction peripheral 120 and “S” denotes the RTSP server 134.

H->W: GET /mfp/cgi-bin/mfpvidsrv?ERR=15078 HTTP/1.1
Host: www.mfpvidsrv.com
Accept: application/sdp
W->H: HTTP/1.0 200 OK
Content-Type: application/sdp
Content-length: 168
v=0
o=− 942715192 942715192 IN IP4 216.35.213.194
s=Maintenance Video Error Code 15078
m=video 0 RTP/AVP 101
a=control:rtsp://www.mfpvidsrv.com:554/mfp/vid/err15078.avi
C->S: SETUP rtsp://www.mfpvidsrv.com:554/mfp/vid/err15078.avi

RTSP/1.0

CSeq: 1
Transport: RTP/AVP/UDP;unicast;client_port=5038-5039
S->C: RTSP/1.0 200 OK
CSeq: 1
Session: 141976
Transport: RTP/AVP/UDP;unicast;client_port=5038-5039;
server_port=5000-5001
C->S: PLAY rtsp://www.mfpvidsrv.com:554/mfp/vid/err15078.avi

RTSP/1.0

CSeq: 2
Session: 141976
S->C: RTSP/1.0 200 OK
CSeq: 2
Session: 141976
RTP-Info: url= rtsp://www.mfpvidsrv.com:554/mfp/vid/err15078.avi;
seq=0;rtptime=0
C->S: TEARDOWN

rtsp://www.mfpvidsrv.com:554/mfp/vid/err15078.avi
RTSP/1.0

CSeq: 3
Session: 141976
S->C: RTSP/1.0 200 OK
CSeq: 3

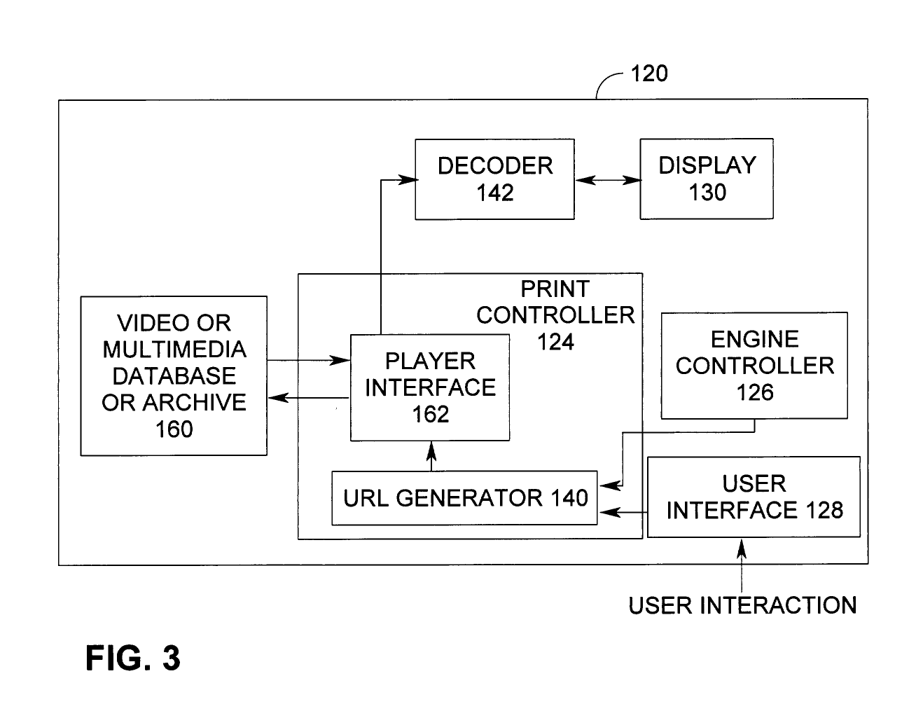

FIG. 3 is a simplified version of an another exemplary preferred embodiment of a multifunction peripheral 120 capable of playing a video stream or multimedia. In this embodiment the multifunction peripheral 120 uses a local video or multimedia database or archive 160 that receives requests from and provides video to a player interface 162. This embodiment may be used alone or in combination with the embodiments of FIGS. 1 and 2.

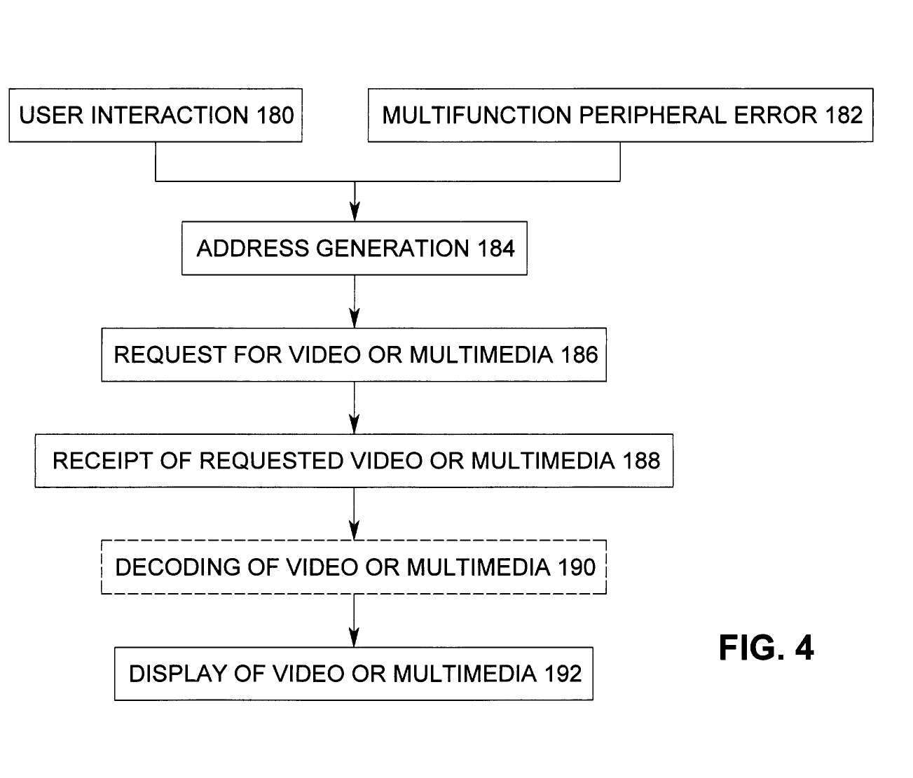

FIG. 4 shows a simplified method performed by a multifunction peripheral that provides streaming video and/or multimedia for adaptive user instructions in response to a multifunction peripheral error and/or user interaction. In this exemplary method, the multifunction peripheral receiving a signal based on a user interaction 180 or a multifunction peripheral error 182. A URL generator 140 or other signal interpreting/address generating means receives the signal, interprets it, and generates an address 184. This generated address is passed to a client system 132, 150, 162 that requests video or multimedia based on the URL 186 from a server system 134, 152, 160. The multifunction peripheral then receives the requested video or multimedia 188. If necessary, the video or multimedia is then decoded 190. The video or multimedia is then displayed 190 on the multifunction peripheral display 130.

The following scenario is provided to show the advantages of the present invention. An unskilled user initially approaches the multifunction peripheral to print three sets of stapled copies. Because the unskilled user is unfamiliar with the multifunction peripheral, he uses a standard button, keyboard, or touch screen “help” key and an introduction video clip plays that illustrates how to access the copy and stapling functions on the user interface. The unskilled user begins to follow these instructions, but before the copying is complete, there is a paper jam. The multifunction peripheral senses the paper jam and either automatically begins playing a video clip illustrating how to fix the problem or displays a message asking the unskilled user if he would like assistance. Following the multimedia presentation (that includes audio), the unskilled user begins to access the machine in various locations to identify and remove the paper jam. As the unskilled user proceeds, however, he accidentally touches a sensitive or dangerous area of the multifunction peripheral. Sensing the violation, the multifunction peripheral automatically plays an audio clip (because the unskilled user may not be focused on the display) warning of the danger. The unskilled user then completes the process of fixing the paper jam and making his copies. As the user is leaving, he is alerted by the multifunction peripheral that he has used the last of the staples in his project and is offered the opportunity to replace the staples. Having had success with the other processes, the now partially skilled user undertakes the maintenance of the multifunction peripheral and replaces the staples as he is guided by a multimedia instructional presentation.

For purposes of this invention, a multifunction peripheral may include a single function device, particularly if the device is complicated. In addition, for purposes of description, the term “video” may also include other types of multimedia presentations. Although shown and described as separate components, the components of the present invention may be implemented in a single chip or using various combinations of components. The present invention may also be a retrofittable unit that attaches to existing multifunction peripherals.

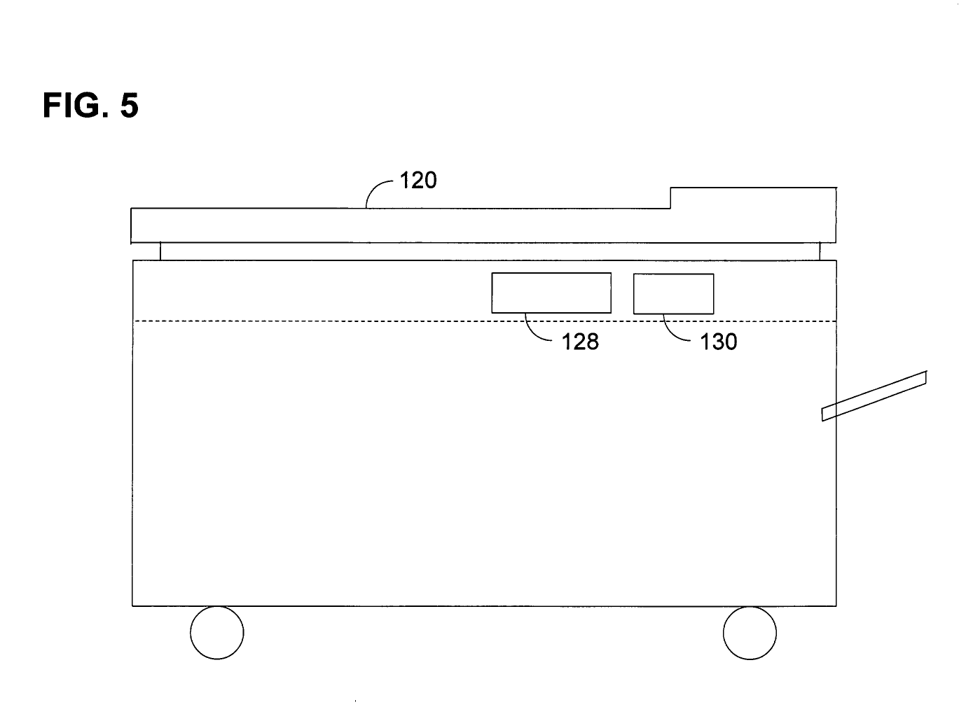

It should be noted that the shown multifunction peripheral is meant to be exemplary and specific features thereof may be changed. For example, as shown on FIG. 5, the user interface 128 may be separate from the display 130 or the user interface 128 may include or be associated with the display 130. The multifunction peripheral's user interface 128 may include any combination of the following exemplary elements as well as additional traditional elements: a keyboard, a key pad, a small and/or text-only display, simple audio alarms, the video-capable display 130, and a speaker (e.g. a full-spectrum audio speaker). Further, it should be noted that user interaction might take place in other locations than the traditional user interface 128. For example, for the purpose of this invention, the multifunction peripheral may be able to sense the user interaction with nontraditional user interfaces such as the paper tray, toner cartridge, staples, developer, or damaged component such that the user interaction therewith is received as a signal.

The present invention may be used in conjunction with the invention described in U.S. patent application No. ______ entitled Interactive Multimedia for Remote Diagnostics and Maintenance of a Multifunction Peripheral (the “Interactive Media” application) and filed on Sep. 30, 2002, concurrently with the present invention, and which was invented by the applicants of the present invention and assigned to the assignee of the present invention. The entire disclosure of the Interactive Media application is incorporated herein by reference.

The terms and expressions that have been employed in the foregoing specification are used as terms of description and not of limitation, and are not intended to exclude equivalents of the features shown and described or portions of them. The scope of the invention is defined and limited only by the claims that follow.

What is claimed is:

1. A method performed by a multifunction peripheral that provides streaming video and/or multimedia for adaptive user instructions in response to a multifunction peripheral error and/or user interaction, said method comprising the steps of:
(a) receiving a signal based on said user interaction or said multifunction peripheral error;
(b) generating an address based on said signal;
(c) requesting video or multimedia based on said address;
(d) receiving said requested video or multimedia; and
(e) displaying said requested video or multimedia on a display associated with said multifunction peripheral.

2. The method of claim 1 further comprising the step of decoding said requested video or multimedia for display on said display associated with said multifunction peripheral.

3. The method of claim 1 wherein said step of requesting video or multimedia further comprises the step of requesting video or multimedia from a remote server.

4. The method of claim 1 wherein said step of requesting video or multimedia further comprises the step of requesting video or multimedia from a local server within said multifunction peripheral.

5. The method of claim 1 wherein said step of displaying said requested video or multimedia on a display further includes the step of playing audio through a speaker associated with said multifunction peripheral.

6. A computer-readable medium associated with a multifunction peripheral, said chip comprising:
(a) means for receiving a signal based on user interaction with said multifunction peripheral or a multifunction peripheral error generated by said multifunction peripheral;
(b) means for generating an address based on said signal;
(c) means for requesting video or multimedia based on said address;
(d) means for receiving said requested video or multimedia; and
(e) means for displaying said requested video or multimedia on a display associated with said multifunction peripheral.

7. The computer-readable medium of claim 6 further comprising means for decoding said requested video or multimedia for display on said display associated with said multifunction peripheral.

8. The computer-readable medium of claim 6 wherein said means for requesting video or multimedia further comprises means for requesting video or multimedia from a remote server.

9. The computer-readable medium of claim 6 wherein said means for requesting video or multimedia further comprises means for requesting video or multimedia from a local server within said multifunction peripheral.

10. The computer-readable medium of claim 6 wherein said means for receiving a signal based on user interaction, said means for generating an address, means for requesting video or multimedia, said means for receiving said requested video or multimedia, and said means for displaying said requested video or multimedia on a display are implemented on a plurality of modules functionally associated to form said computer-readable medium.

11. The computer-readable medium of claim 6 wherein said means for displaying said requested video or multimedia on a display further includes means for playing audio through a speaker.

12. A multifunction peripheral, comprising:
(a) a multifunction peripheral;
(b) an error generator for generating at least one multifunction peripheral error signal;
(c) means for receiving said multifunction peripheral error signal;
(d) an address generator, said address generator generating an address based on said multifunction peripheral error signal;
(e) a client system, said client system receiving said address for requesting video or multimedia based on said address;
(f) a server system, said server system receiving said request for video or multimedia and returning requested video or multimedia to said client system; and
(g) a display, said display receiving said video or multimedia from said client system and displaying said video or multimedia thereon.

13. The multifunction peripheral of claim 12 further comprising a decoder for receiving said video or multimedia and decoding said video or multimedia for display on said display.

14. The multifunction peripheral of claim 12 further comprising means for receiving a signal based on user interaction, said user interaction producing an error signal to be received by said error generator.

15. The multifunction peripheral of claim 12 wherein said server system is a remote server.

16. The multifunction peripheral of claim 12 wherein said server system is a local server.

17. The multifunction peripheral of claim 12 wherein said multifunctional peripheral error is at least one error selected from the group consisting of:
(a) a simple maintenance problem;
(b) an everyday problem associated with basic maintenance and servicing;
(c) technical problems;
(d) installation of initial hardware and software; and
(e) field upgrades of hardware and software.

18. The multifunction peripheral of claim 12, said display receiving audio from said client system and playing audio thereon.

19. The multifunction peripheral of claim 12 further including audio projectors, said audio projectors receiving audio from said client system and playing audio thereon.

20. A computer program comprising instructions for causing a multifunction peripheral to perform the acts of:
(a) receiving a signal based on a user interaction or a multifunction peripheral error;
(b) generating an address based on said signal;
(c) requesting video or multimedia based on said address;
(d) receiving said requested video or multimedia; and
(e) displaying said requested video or multimedia on a display associated with said multifunction peripheral.
